(19) United States
(12) Patent Application Publication
(10) Pub. No.: US 2010/0153283 A1
(43) Pub. Date: Jun. 17, 2010

(54) ELECTRONIC PROFESSIONAL MENTORING FRAMEWORK

(75) Inventors: EDWIN J. BRUCE, CORINTH, TX (US); ROMELIA H. FLORES, KELLER, TX (US)

Correspondence Address: PATENTS ON DEMAND, P.A. - IBM CHA, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/334,283

(22) Filed: Dec. 12, 2008

(51) Int. Cl. G06Q 10/00; G06Q 90/00

(52) U.S. Cl. 705/319; 705/326

(57) ABSTRACT

Mentoring relationships between mentors and protégés can be established within mentoring data that conforms to standards of a mentoring framework. For each mentoring relationship, a mentoring path can be established. Each mentoring path can include a set of defined phases, each phase having a bounded beginning and ending, each phase further including at least one goal, at least one activity completion of which marks a progression towards achieving an associated goal, and timelines associated with at least one of the activities. Interactive user interfaces can be presented upon network attached client devices to users assigned a mentoring role who participate in at least one mentoring relationship for which the mentoring data is maintained. Performance input can be received via the interactive user interfaces, which results in the mentoring data being updated. “Web 2.0-style” techniques can be leveraged to gather rating and access information associated with content or electronic assets, thereby augmenting “conventional” approaches that rate only the delivery of the mentorship relationship itself A progression along the mentoring path can be changed based upon the updated mentoring data.

### BACKGROUND

The present invention relates to the field of professional mentoring and, more particularly, to an electronic professional mentoring framework.

Mentoring is a common practice utilized in a variety of situations for individuals to improve or expand their knowledge and/or experience. In the corporate sector, mentoring is often a means to prepare an employee for new responsibilities or improve existing skills. Such professional mentoring programs are generally loosely organized and without standardized governance or monitoring.

As such, current professional mentoring programs fail to measure the effectiveness of the mentoring relationships, called mentorships, between mentors and protégés. This lack of a framework that captures data and feedback about the interactions conducted during the mentorship propagates a cycle of ineffectiveness, frustration, and unrealized potential for both the professional mentorship program and the protégés.

### BRIEF SUMMARY

One aspect of the present invention can include a method and computer program product for implementing mentoring in conformance with a mentoring framework. In this aspect, mentoring relationships between mentors and protégés can be established within mentoring data that conforms to standards of a mentoring framework. For each mentoring relationship, a mentoring path can be established. Each mentoring path can include a set of defined phases, each phase having a bounded beginning and ending, each phase further including at least one goal, at least one activity completion of which marks a progression towards achieving an associated goal, and timelines associated with at least one of the activities. Interactive user interfaces can be presented upon network attached client devices to users assigned a mentoring role who participate in at least one mentoring relationship for which the mentoring data is maintained. Performance input can be received via the interactive user interfaces, which results in the mentoring data being updated. “Web 2.0-style” techniques can be leveraged to gather rating and access information associated with content or electronic assets, thereby augmenting “conventional” approaches that rate only the delivery of the mentorship relationship itself. A progression along the mentoring path can be changed based upon the updated mentoring data.

Another aspect of the present invention can include a system for providing an electronic professional mentoring environment. The system can include a mentorship path configured to define a series of interactions between at least one mentor and a protégé to achieve a predetermined end-goal for the protégé. The mentorship path can be supervised by at least one mentorship administrator. The series of interactions of the mentorship path can include a set of phases, each having at least one activity to be performed. The system can also include a mentorship framework configured to enable mentors, protégés, and mentorship administrators to perform a set of operations within an electronic environment. The operations can signify progression of the protégé along the mentorship path. Mentorship data generated by the set of operations can be captured to create a knowledge base for use by mentors and administrators to improve subsequent mentorship paths and interactions.

### BRIEF DESCRIPTION OF THE SEVERAL VIEWS OF THE DRAWINGS

FIG. 1 is a schematic diagram illustrating a scenario for utilizing a mentorship framework for a mentorship program in accordance with embodiments of the inventive arrangements disclosed herein.

FIG. 2 is a schematic diagram illustrating a system for implementing a mentorship framework in accordance with an embodiment of the inventive arrangements disclosed herein.

FIG. 3 is an illustration of a sample logical component diagram for the mentorship framework in accordance with an embodiment of the inventive arrangements disclosed herein.

FIG. 4 illustrates a collection of sample textual-environment mentorship interfaces to a mentorship framework in accordance with embodiments of the inventive arrangements disclosed herein.

FIG. 5 illustrates a sample virtual world-based mentorship user interface to a mentorship framework in accordance with embodiments of the inventive arrangements disclosed herein.

### DETAILED DESCRIPTION

The present disclosure includes a professional mentoring framework that provides electronic facilitation and governance of mentorships. A mentorship can be expressed in an electronic document called a mentorship path, which defines the various phases and activities that the protégé is to complete to achieve a predetermined end-goal. The phases and/or activities of the mentorship path can have associated mentorship requirements that define additional parameters of the phase/activity, such as the assigned mentor and time constraints.

When performing the phases/activities of the mentorship, the protégé and the mentor can utilize the mentorship framework to capture and share information. The mentorship framework can represent a conglomerate of software tools configured specifically for the professional mentoring program, providing a variety of services and interfaces. A variety of mentorship data, such as participant feedback, can be collected within the mentorship framework. A mentorship administrator, overseeing the overall mentorship path as well as the performance of phases/activities, can utilize the mentorship data to mitigate mentorship issues as well as improve the professional mentoring program. Mentorship data can also be utilized by mentors and protégés themselves, as they also have the capability to oversee phases and activities.

The present invention may be embodied as a method, system, or computer program product. Accordingly, the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.” Furthermore, the present invention may take the form of a computer program product on a computer usable storage medium having computer usable program code embodied in the medium. In a preferred embodiment, the invention is implemented in software, which includes but is not limited to firmware, resident software, microcode, etc.

Furthermore, the invention can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. Examples of a computer readable medium include a semiconductor or solid state memory, magnetic tape, a removable computer diskette, a random access memory (RAM), a read-only memory (ROM), an erasable programmable read-only memory (EPROM) or Flash memory, a rigid magnetic disk and an optical disk. Current examples of optical disks include compact disc-read only memory (CD-ROM), compact disc-read/write (CD-R/W) and DVD. Other computer readable media can include transmission media, such as those supporting the Internet, an intranet, a personal area network (PAN), or a magnetic storage device. Transmission media can include an electrical connection having one or more wires, an optical fiber, an optical storage device, and a defined segment of the electromagnetic spectrum through which digitally encoded content is wirelessly conveyed using a carrier wave.

Note that the computer usable or computer readable medium can even include paper or another suitable medium upon which the program is printed, as the program can be electronically captured, for instance, via optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the C programming language or similar programming languages. The program code may execute entirely on the user's computer, partly on the user's computer, as a stand-alone software package partly on the user's computer and partly on a remote computer, or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of instances code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

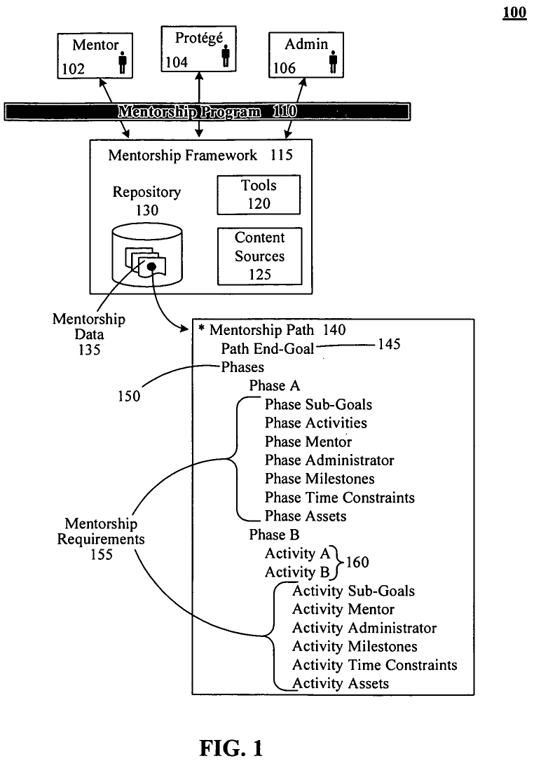

FIG. 1 is a schematic diagram illustrating a scenario 100 for utilizing a mentorship framework 115 for a mentorship program 110 in accordance with embodiments of the inventive arrangements disclosed herein. In scenario 100, a mentor 102, a protégé 104, and a mentorship administrator 106 can utilize the mentorship framework 115 to support the conduct of the mentorship program 110.

The mentorship program 110 can represent a general set of guidelines that define the basic conditions of a mentorship between a mentor 102 and a protégé 104. For example, requirements for participating as a mentor 102 and/or protégé 104 as well as completion deadlines can be defined within the mentorship program 110. The mentorship program 110 can be designed to function entirely within an organization or as a foundation for creating mentorships with external entities.

A key function of a mentorship program 110 can be to increase the knowledge and/or skills of individuals, called protégés 104, through interaction with a knowledgeable entity, called a mentor 102. For example, a high-level manager can act as a mentor 102 to a lower-level manager 104 to improve the management skills of the lower-level manager 104. Mentorship relationships between mentors 102 and protégés 104 can include one-to-one relationships, one-to-many relationships, many-to-one relationships, and many-to-many relationships.

The mentorship administrator 106 can represent one or more people who oversee the performance of the mentorship program 110. In general, mentorship administrators 106 can provide a variety of services to the mentors 102 and protégés 104, such as, but not limited to mentorship management, mentorship creation, dispute resolution, resource assistance, and the like.

The mentorship framework 115 can represent an electronic infrastructure usable by the mentor 102, protégé 104, and mentorship administrator 106 that supports the functions of the mentorship program 110. Within the mentorship framework 115, the mentoring of a protégé 104 can be represented as a mentorship path 140. The mentorship path 140 can represent an outline of phases 150 and/or activities 160 to be performed by mentors 102 and protégés 104 to achieve a predetermined path end-goal 145.

Phases 150 can correspond to broad steps, skills, and/or concepts that protégés 104 require experience with and/or knowledge about in order to exit a current phase 150 and ultimately progress toward the end-goal 145. For example, a protégé 104 with an end-goal 145 of “Management Position” can have a mentorship path 140 containing phases 150 of “Business Administration” and “Personnel Handling”.

To drive acquisition of the necessary skills and understanding, a phase 150 can contain one or more appropriate activities 160. An activity 160 can represent an assignment or event, such as a meeting, to be performed by a mentor 102 and/or protégé 104. Expanding upon the above example, the “Personnel Handling” phase 150 can have activities 160 for “Conflict Resolution”, “Performance Reviews”, and “Hiring/Firing Skills”.

A phase 150 and/or activity 160 can have one or more associated mentorship requirements 155. The mentorship requirements 155 can represent specific conditions or assignment of resources for the performance of the phase 150 or activity 160. As shown in the above example, the mentorship requirements 155 of “Phase A” can include sub-goals, activities, a mentor, an administrator, milestones, time constraints, and assets.

The mentorship paths 140 can provide various levels of granularity for the use of mentors 102 to assist protégés 104 in achieving their end-goals 145. As shown in the above example, a mentor 102 can be assigned at the phase 150 and/or activity 160 level, allowing for the skills/experience of the mentors 102 to be utilized more effectively than traditional mentorship programs 110 that foster the relationship of a protégé 104 and only one mentor 102 for the entirety of a mentorship. Additionally, flexibility within mentorship paths 140 can result in protégés 104 only needing single mentorship paths 140 throughout their careers, as additional phases 150 and/or activities 160 can be added and mentorship parameters 155 modified to correspond with career developments.

To support performance of the mentorship path 140, and the mentorship program 110 as a whole, the mentorship framework 115 can include tools 120, content sources 125, and a repository 130 containing mentorship data 135. The tools 120 can correspond to a variety of software applications that support functions required by the mentorship program 110 and mentorship path 140. The tools 120 can provide the mentor 102 and/or protégé 104 with access to the mentorship path 140 as well as various content sources 125.

The content sources 125 can represent a variety of electronic assets such as documents and videos that can be presented to mentors 102 and/or protégés 104 during performance of phases 150 and/or activities 160 of mentorship paths 140. For example, content sources 125 for use with the “Conflict Resolution” activity 160 can include an electronic copy of an internal memo and a simulation for the protégé 104 to work through. The content sources 125 can also include items created by the tools 120 as well as paths or links to data that is stored external to the mentorship framework 1 15.

In addition to basic operational data, such as information about mentors 102 and protégés 104, mentorship data 135 can be collected by the various tools 120 within the mentorship framework 115 about the mentorship paths 140 of the mentorship program 110. For example, feedback from mentors 102 and protégés 104 about various interactions can be collected. Tools 120 can be used by all mentorship framework users 102, 104, 106 to assess/improve user 102, 104, 106 effectiveness and that of the mentorship program 110.

The mentorship framework 115 can support a variety of different types of mentoring programs established for any definable goal. Specifics of the mentorship paths 140, tools 120, content sources 125, and managed mentorship data 135 will vary depending upon implementation specifics. In one implementation, for example, the mentors 102 and protégés 104 can physically interact in proximity to one another, in which case the mentorship framework 115 is used for guidance and recording purposes. In another implementation, interactions between mentors 102 and protégés 104 can be conducted through remote correspondence mechanisms, such as email, on-line chatting, text messaging, co-browsing, and the like, each of which can be one of the tools 120 of the framework 115.

In one embodiment, a degree of anonymity can be maintained throughout mentoring relationships. That is, real-world identities of mentors 102 and protégés 104 can be selectively hidden from one-another. In such an embodiment, the mentorship framework 115 can verify the qualifications of a mentor 102 for a given purpose without necessarily disclosing identifying details to a protégé 104. Of course, a qualification verification mechanism can optionally be built into the mentorship framework 115 and used when identities of the various parties 102, 104 are disclosed to each other.

As used herein, the presented repository 130 can be a physical or virtual storage space configured to store digital information. Repository 130 can be physically implemented within any type of hardware including, but not limited to, a magnetic disk, an optical disk, a semiconductor memory, a digitally encoded plastic memory, a holographic memory, or any other recording medium. Repository 130 can be a stand-alone storage unit as well as a storage unit formed from a plurality of physical devices. Additionally, information can be stored within repository 130 in a variety of manners. For example, information can be stored within a database structure or can be stored within one or more files of a file storage system, where each file may or may not be indexed for information searching purposes. Further, repository 130 can utilize one or more encryption mechanisms to protect stored information from unauthorized access.

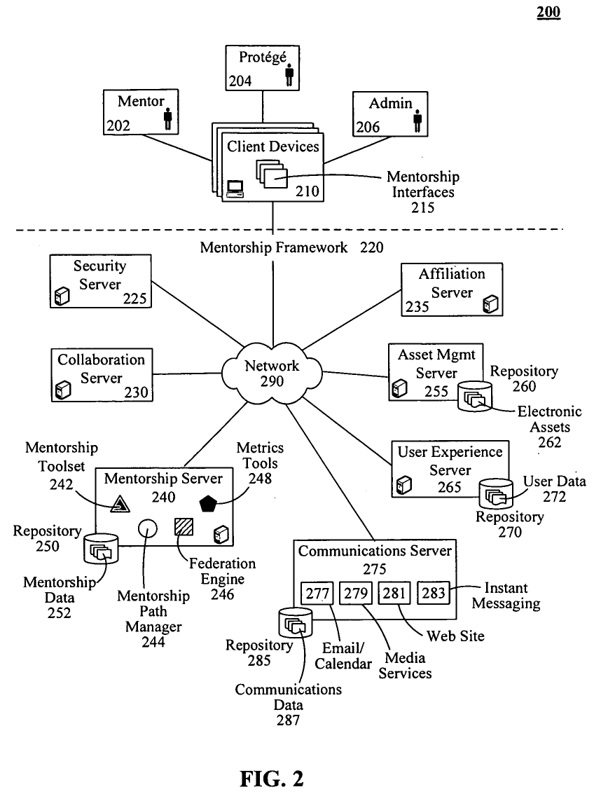

FIG. 2 is a schematic diagram illustrating an example system 200 for implementing a mentorship framework 220 in accordance with embodiments of the inventive arrangements disclosed herein. System 200 can represent a specific embodiment of the mentorship framework 115 of scenario 100 of FIG. 1.

In system 200, a mentor 202, a protégé 204, and a mentorship administrator 206 can utilize mentorship interfaces 215 that interface with software applications of various servers 225, 230, 235, 240, 255, 265, and 275 over the network 290 to perform activities supported by a mentorship framework 220.

The mentor 202, protégé 204, and mentorship administrator 206 can access the mentorship interfaces 215 using a client device 210 capable of communicating with the various servers 225, 230, 235, 240, 255, 265, and 275 over the network 290. A client device 210 can represent a variety of electronic computing devices capable of executing the mentorship interfaces 215. Examples of a client device 210 can include, but are not limited to, a personal computer, a personal digital assistant (PDA), a mobile phone, a computing kiosk, and the like.

The mentorship interfaces 215 can represent the user interfaces used by the mentor 202, protégé 204, and mentorship administrator 206 to perform functions within the mentorship framework 220. The mentorship interfaces 215 can be configured to provide access to and present data and functions specifically for each type of user. That is, a mentorship interface 215 used by a mentor 202 can present the data and functions that are specific to the tasks of a mentor 202, whereas the mentorship interface 215 used by a protégé 204 can present different data and functions, and similarly with the mentorship interface 215 used by a mentorship administrator 206. It is also contemplated that a comment set of one or more views be shared across any or all user roles (mentor, protégé, or administrator).

For example, a mentor's 202 mentorship interface 215 can include a section that allows him/her to rate the performance of a protégé 204. The protégé's 204 mentorship interface 215 can have a section for rating a mentor 202. The mentorship interfaces 215 of administrators 206, mentors 202 and protégés 204 can view the ratings provided by mentors 202 and protégés 204.

As shown in this example, the functionality of the mentorship framework 220 can be supported by a security server 225, a collaboration server 230, an affiliation server 235, a mentorship server 240, an asset management server 255, a user experience server 265, and a communications server 275. The servers 225, 230, 235, 240, 255, 265, and 275 can be configured to utilize standard communication protocols to communicate over the network 290 with each other, the client device 210, and mentorship interfaces 215.

Each server 225, 230, 235, 240, 255, 265, and/or 275 can provide a specific type of functionality to the mentorship framework 220. The security server 225 can represent the hardware and/or software that control access to the mentorship framework 220. That is, a mentor 202, protégé 204, and mentorship administrator 206 cannot access the mentorship framework 220 without proper registration with the security server 225.

The collaboration server 230 can represent the hardware and/or software that provide functionality for the mentor 202 and protégé 204 to perform online collaboration regarding various electronic documents. The functionality of the collaboration server 230 can be accessed through and/or presented within the mentorship interfaces 215.

The affiliation server 235 can represent the hardware and/or software that can determine degrees of affiliation between mentors 202 and protégés 204. The affiliation server 235 can utilize the user data 272 collected by the user experience server 265 and/or separately requested data to perform such determinations. For example, mentors 202 and protégés 204 can be required to answer a questionnaire when registering for the mentorship framework 220. The data of the questionnaire can be used by the affiliation server 235 to determine commonalities between potential mentors 202 and protégés 204.

The asset management server 255 can represent the hardware and/or software that control access to various electronic assets 262 contained within an associated repository 260. In addition to access control, the asset management server 255 can also handle version control of the electronic assets 262. The electronic assets 262 can represent a variety of electronic data, such as, but not limited to, text files, video files, audio files, simulation programs, image files, and the like. The electronic assets 262 stored within the repository 260 can be created by other software applications of the mentorship framework 220, such as those of the collaboration server 230, and/or imported from external sources.

The user experience server 265 can represent the hardware and/or software that support the presentation of the mentorship framework 220 within the mentorship interfaces 215. The user experience server 265 can include a repository 270 for storing user data 272. User data 272 can represent a variety of user-specific data items, such as interface customizations and personal information.

Presentations provided by the user experience server 265 can leverage the functionality of a variety of social networking applications that interact with the other servers 225, 230, 235, 240, 255, and 275. For example, the user experience server 265 can provide a protégé 204 with an interaction-capable virtual “world view” of the mentorship framework 220 in addition to a Web site perspective. While the same information can be presented within both perspectives, each perspective can provide the protégé 204 with a different interaction medium (i.e., graphical vs. textual).

The communications server 275 can represent the hardware and/or software that provide communication services between the servers 225, 230, 235, 240, 255, 265, and 275 and client devices 210 over the network 290. As shown in this example, the communications server 275 can provide the mentorship framework 220 with email/calendar 277, media services 279, Web site hosting 281, and instant messaging 283.

It should be noted that the communications server 275 can be configured to accommodate any combination of communication services required by the mentorship framework 220. Further, the communications server 275 can represent a cluster of individual servers that each provide a specific communication service

Communications data 287 created by the various communication services 277, 279, 281, and 283, such as email messages and instant message conversations, can be stored in an associated repository 285.

The communication services 277, 279, 281, and 283 of the communications server 275 can fulfill the communication requirements of other servers 225, 230, 235, 240, 255, and 265. For example, a social networking tool of the user experience server 265 can utilize the instant messaging service 283 of the communications server 275 instead of establishing a local instant messaging service.

The mentorship server 240 can represent the hardware and/or software that provide governance of the mentorship framework 220. The mentorship server 240 can include a mentorship toolset 242, a mentorship path manager 244, a federation engine 246, a set of metrics tools 248, and a repository 250 containing mentorship data 252.

The mentorship toolset 242 can be a software application configured to provide mentorship governance functions. The mentorship toolset 242 can enable mentorship administrators 206 to analyze mentorship data 252 for quantitative assessments of individual mentorship participants and/or the overall mentorship program. For example, all framework users 202, 204, 206 can utilize the mentorship toolset 242 to assess the performances of specific mentors 202 and protégés 204 based on the feedback provided for specific interactions.

To perform such functionality, the mentorship toolset 242 can utilize a federation engine 246 and metrics tools 248. The federation engine 246 can be a component of the mentorship server 240 that aggregates specifically requested data from a variety of sources, such as the various repositories 260, 270, and 285 of the mentorship framework 220. The metrics tools 248 can represent a software application that provides data analysis functionality.

The mentorship path manager 244 can represent the software application configured to handle creation/modification of mentorship paths (not shown), such as that illustrated in FIG. 1, for mentors 202 and protégés 204.

It should be noted that the servers 225, 230, 235, 240, 255, 265, and 275 shown in system 200 can be arranged and/or consolidated without detracting from the functionality of the present embodiment of the invention. For example, the user experience server 265 can operate on the same physical hardware server as the affiliation server 235.

In an alternate embodiment, repositories 250, 260, 270, and 285 can be logical segments of a single physical data structure, such as separate databases hosted on the same database server. In such an embodiment, a remote server can access the necessary data over the network 290.

The various components of framework 220 can interact in a number of different implementation contexts. In one context, for example, the mentorship server 240 can be a component designed and maintained independent of other ones of the framework 220. That is, the mentorship server 240 can function as an integrator, which leverages applications and/or software components, such as commercial-off-the-shelf calendaring programs, email programs, social networking programs, etc., maintained by others and unifies them into a comprehensive mentoring package.

In one embodiment, the mentorship server 240 can serve customized portals presentable upon client devices 210, each tailored for a user 202, 204, 206 and that user's role in a mentoring relationship. In one implementation, a model-view-controller (MVC) approach can be taken for framework 220, where programmatic distinctions are built into the framework 220 to isolate business logic from user interface considerations. In one implementation, Web 2.0 technologies (e.g., Mash-ups, Blogs, WIKIs, etc.) can be used to facilitate interactive collaborations and user 202-206 driven customizations during a mentoring relationship. In one implementation, at least a portion of the framework 220 can conform to a service oriented architecture (SOA) standard. In one embodiment, functional components of the mentoring framework 220 can be implemented as software services, which include Web services.

Network 290 can include any hardware/software/and firmware necessary to convey data encoded within carrier waves. Data can be contained within analog or digital signals and conveyed though data or voice channels. Network 290 can include local components and data pathways necessary for communications to be exchanged among computing device components and between integrated device components and peripheral devices. Network 290 can also include network equipment, such as routers, data lines, hubs, and intermediary servers which together form a data network, such as the Internet. Network 290 can also include circuit-based communication components and mobile communication components, such as telephony switches, modems, cellular communication towers, and the like. Network 290 can include line based and/or wireless communication pathways.

As used herein, presented repositories 250, 260, 270, and 285 can be a physical or virtual storage space configured to store digital information. Repositories 250, 260, 270, and 285 can be physically implemented within any type of hardware including, but not limited to, a magnetic disk, an optical disk, a semiconductor memory, a digitally encoded plastic memory, a holographic memory, or any other recording medium. Repositories 250, 260, 270, and 285 can be a stand-alone storage unit as well as a storage unit formed from a plurality of physical devices. Additionally, information can be stored within repositories 250, 260, 270, and 285 in a variety of manners. For example, information can be stored within a database structure or can be stored within one or more files of a file storage system, where each file may or may not be indexed for information searching purposes. Further, repositories 250, 260, 270, and/or 285 can utilize one or more encryption mechanisms to protect stored information from unauthorized access.

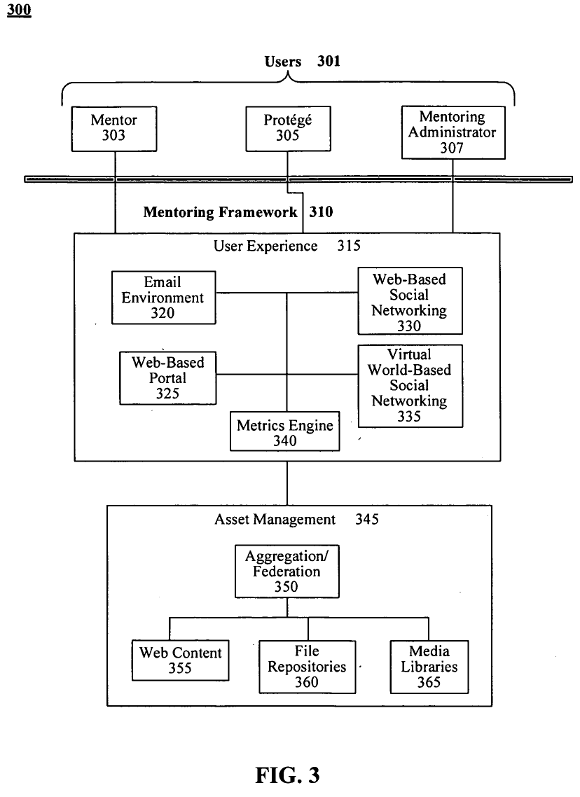

FIG. 3 is an illustration of a sample logical component diagram 300 for the mentorship framework 310 in accordance with embodiments of the inventive arrangements disclosed herein. The sample logical component diagram 300 can be a representation of the mentorship framework of FIG. 1 and/or FIG. 2.

The users 301 of the mentorship framework 310 can include mentors 303, protégés 305, and mentoring administrators 307. All users 301 can directly access the user experience component 315 of the mentorship framework 3 10.

The user experience component 315 can contain the elements of the mentorship framework 310 that the users 301 utilize for interaction with each other and/or elements of the mentorship framework 310. As shown in this example, the user experience component 315 can include an email environment 320, a Web-based portal 325, Web-based social networking 330, virtual world-based social networking 335, and a metric engine 340.

The user experience component 315 can interact with the asset management component 345. The asset management component 345 can encompass elements of the mentorship framework 310 associated with electronic assets. In this example, the asset management component 345 can include an aggregation/federation element 350, Web content 355, file repositories 360, and media libraries 365. The aggregation/federation element 350 can be responsible for the extraction and/or proliferation of data from the other elements of the asset management component 345.

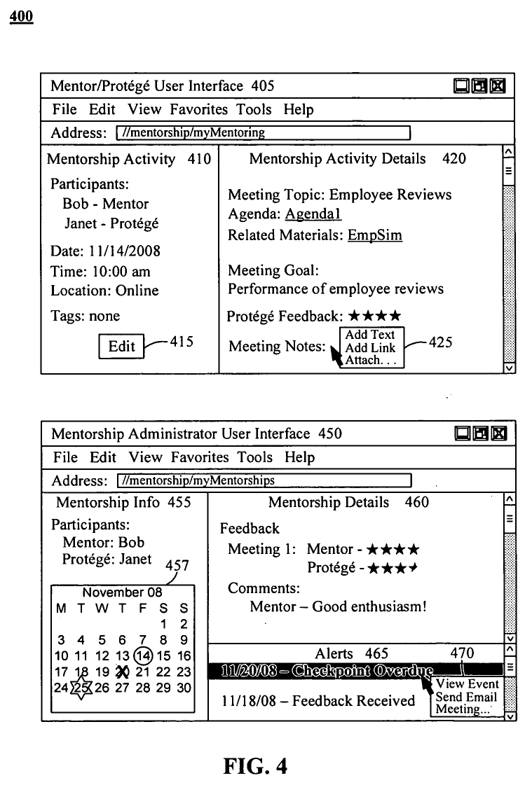

FIG. 4 illustrates a collection 400 of sample textual-environment mentorship user interfaces 405 and 450 to a mentorship framework in accordance with embodiments of the inventive arrangements disclosed herein. The sample textual-environment mentorship user interfaces 405 and 450 of collection 400 can represent the mentorship interfaces 215 of system 200 and/or provide interaction with the user experience 315 of component diagram 300.

It should be noted that the textual-environment mentorship user interfaces 405 and 450 of collection 400 are for illustrative purposes only, and are not intended to represent a comprehensive embodiment. As such, additional components and/or configurations can be included without deviating from the spirit of the present disclosure.

The textual-environment mentorship user interfaces 405 and 450 of collection 400 can present a variety of data and/or functionality to a mentor/protégé and a mentorship administrator, respectively. These textual-environment mentorship user interfaces 405 and 450 can be configured to present the data and/or functionality to the intended user that utilizes text as the primary presentation medium.

That is, presentation of the data within the textual-environment mentorship user interfaces 405 and 450 can be based upon a textual file or document, which can be capable of incorporating the use of audio and/or graphical elements within the presentation. For example, a mentorship framework with a Web-based infrastructure can utilize Web browsers as the textual-environment mentorship user interfaces 405 and 450 to present data contained within Web pages, as shown in FIG. 4.

The various entities (mentor, protégé, and mentorship administrator) participating in a mentorship can require access to different tools and content sources from the mentorship framework. As such, the textual-environment mentorship user interfaces 405 and 450 can be configured to present data and/or functionality tailored to the specific role of the user. In collection 400, textual-environment mentorship user interface 405 can illustrate an interface configured for a mentor and/or protégé participating in a mentorship, whereas textual-environment mentorship interface 450 can represent an interface tailored to meet the needs of potentially all framework users.

It should be emphasized that the mentorship framework can encompass a vast multitude of data and functions, and that those items illustrated within the user interfaces 405 and 450 of collection 400 are meant only as exemplary representations.

As shown in this example, the mentor/protégé user interface 405 can be configured to present information about a specific mentorship activity 410 and its associated mentorship activity details 420. The mentorship activity section 410 can display high-level information, such as the participants and schedule, of a specific activity occurring during the protégé's mentorship path. The mentorship activity details section 420 can present the specific information related to the activity displayed in the mentorship activity section 410.

The mentorship activity section 410 and/or mentorship activity details section 420 can also include the capability to perform various functions related to the data being presented. For example, the review of an online meeting can offer the option to view a conversation log. Execution of functions can be implemented in a variety of means that are commensurate with the implementation of the mentor/protégé user interface 405, such as the EDIT button 415 and context menu 425 shown in this example.

In another contemplated embodiment, the mentorship activity section 410 can perform a navigation functionality that allows a user to select various activities to view and/or actions to perform. In such an embodiment, the mentorship activity details section 420 can be configured to include presentation of the high-level activity data.

Since the mentorship administrator supervises mentorships, the mentorship administrator user interface 450 can be configured to aggregate and synthesize data collected within the mentorship framework from users of the mentor/protégé user interface 405. As shown in this example, the mentorship administrator user interface 450 can present the mentorship administrator with a different view of the data shown in the mentor/protégé user interface 405.

The mentorship administrator user interface 450 can include sections to present general mentorship information 455, specific mentorship details 460, and alerts 465. The mentorship information section 455 can provide basic and/or high-level information about the mentorship, such as the mentorship participants and activities. This information can utilize various formats and/or interfaces with other tools in use within the mentorship framework, such as the calendar 457 shown in this example.

The mentorship details section 460 can present the mentorship administrator with an overview of the mentorship that can include data from both the participating mentors and protégés. As shown, the presented data can include designations as to the source, mentor(s) or protégé(s).

The alerts section 465 can provide the mentorship administrator with important notices, as determined by the mentorship framework. Further, the data presented within the alerts section 465 can be synchronized with the data of the other sections 455 and 460. As shown in this example, the highlighted alert corresponds to a date on the calendar 457 of the mentorship information section 455 marked with an “X”.

As with the mentor/protégé user interface 405, the sections 455, 460, and/or 465 can also include the capability to perform various functions related to the data being presented. Execution of functions can be implemented in a variety of means that are commensurate with the implementation of the mentorship administrator user interface 450, such as context menu 470 shown in this example.

It should be noted that the information and functionality illustrated in the mentor/protégé 405 and mentorship administrator user interfaces 450 must be supported and/or accessible by the mentorship framework. That is, meeting schedule data must be available from a repository within the mentorship framework. Changes to the meeting schedule data from within either user interface 405 and/or 450 can only occur when the mentorship framework contains a corresponding calendar/scheduling tool.

Further, textual presentation of the information within the mentor/protégé 405 and mentorship administrator user interfaces 450 can utilize a variety of approaches that are commensurate with the implementation of the user interfaces 405 and 450, such as cascading style sheets (CSS), document templates, and the like.

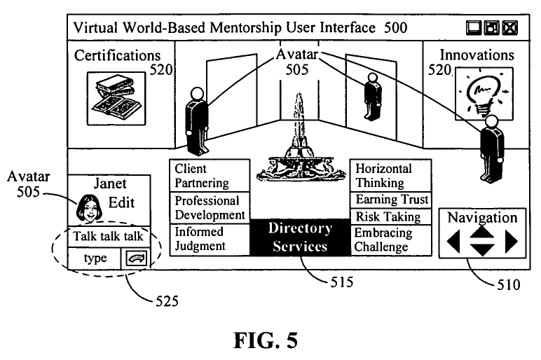

FIG. 5 illustrates a sample virtual world-based mentorship user interface 500 to a mentorship framework in accordance with embodiments of the inventive arrangements disclosed herein. The sample virtual world-based mentorship user interface 500 can represent a mentorship interface 215 of system 200 and/or provide interaction with the user experience 315 of component diagram 300.

The virtual world-based mentorship user interface 500 can interface with a component of the mentorship framework, such as the virtual world-based social networking component 335 of component diagram 300. The virtual world-based mentorship user interface 500 can present the data and/or functionality of the mentorship framework as a graphically-animated experience. In one embodiment, for example, interface 500 can be a mentoring interface provided within a virtual world program, such as SECOND LIFE.

As shown in this example, the mentorship framework is graphically represented similar to a shopping mall. Participants (mentors, protégés, and mentorship administrators) in mentorships can create virtual representations of themselves, called avatars, and can browse the offerings of the mentorship framework, herein referred to as the mentorship mall, by literally walking throughout the mentorship mall.

Movement through the mentorship mall can utilize a set of navigation controls, such as navigation buttons 510. For example, selecting the Left Arrow navigation button 510 can cause an avatar within the virtual world-based mentorship user interface 500 to rotate a predetermined amount to the left.

The mentorship mall can have multiple areas or sections which can be presented to a user as a directory 515. Selection of an item presented within the directory 515 can result in that area of the mentorship mall being rendered within the virtual world-based mentorship user interface 500.

Services of the mentorship program can be represented within the mentorship mall as stores 520. In this example, the portion of the mentorship mall presented within the virtual world-based mentorship user interface 500 contains stores 520 for certifications and innovations. Using the navigation controls 510, a user can maneuver their avatar 505 into a store 520 to receive information specific to that topic.

For example, the certifications store 520 can be represented as a bookstore with shelves of books that represent various certifications. Selection of a book by the avatar can result in the display of information specific to the selected certification.

Thus, a user of the virtual world-based mentorship user interface 500 can interact with the various objects presented in the mentorship mall. This includes interaction with other users' avatars 505. The virtual world-based mentorship user interface 500 can include access to the communication services of the mentorship framework infrastructure. As shown in this example, avatars 505 in proximity to each other can communicate with each other using a chat room 525 or equivalent voice facility.

The diagrams in FIGS. 1-5 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, have functions executed substantially concurrently, or those functions may sometimes be executed in the reverse order, depending upon the functionality involved. It should also be noted that each block of the block diagrams and/or flowchart illustration, and combinations of blocks in the block diagrams and/or flowchart illustration, can be implemented by special purpose hardware-based systems that perform specified functions or acts, or by combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for implementing mentoring in conformance with a mentoring framework comprising:
establishing a plurality of mentoring relationships between mentors and protégés within mentoring data maintained in a database structure that is digitally encoded in a storage medium, wherein the mentoring data conforms to standards of a mentoring framework;
for each mentoring relationship establishing a mentoring path, each mentoring path comprising a plurality of defined phases, each phase having a bounded beginning and ending, each phase further comprising at least one goal, at least one activity completion of which marks a progression towards achieving an associated goal, and timelines associated with at least one of the activities;
presenting interactive user interfaces upon network attached client devices to users assigned a mentoring role who participate in at least one mentoring relationship for which the mentoring data is maintained in the storage medium, wherein each of the interactive user interfaces presents mentoring path information to a user in a manner customized for the mentoring role of that user, wherein said mentoring roles comprise at least a mentor role and a protégé role;
receiving performance input via the interactive user interfaces from a set of users, wherein the performance input is associated with a phase, goal, or activity of the mentoring path corresponding to the mentoring relationship of or being overseen by the user of the interactive user interface;
updating the mentoring data based upon performance input; and
potentially changing a progression along the mentoring path based upon the updated mentoring data.

2. The method of claim 1, further comprising:
federating data from a plurality of sources, wherein the federated data conforms to standards of the mentoring framework and is integrated within stages of the mentoring path; and
updating the mentoring data associated with a mentoring path based upon the federated data.

3. The method of claim 2, wherein the plurality of sources comprise at least one social networking source, and at least one electronic communication source, each of which are implemented independent of the mentoring framework, wherein federating data from the plurality of sources involves transforming a format of semantic content extracted from each source from an original format to a format conforming to the mentoring framework.

4. The method of claim 3, wherein semantic content extracted from each source is associated with programmatic triggers configured to selectively fire depending upon the semantic content, wherein firing results in an execution of a previously configured programmatic rule, which causes the mentoring data maintained in the storage medium to be automatically updated.

5. The method of claim 1, further comprising:
establishing a plurality of programmatic rules and programmatic triggers related to each of the phases, activities, and goals of an established mentoring path;
detecting an occurrence of an event associated with a programmatic trigger;
applying programmatic actions defined by one of the programmatic rules responsive to detecting the occurrence; and
automatically updating the mentoring data responsive to the applied programmatic actions.

6. The method of claim 5, further comprising:
defining metrics for each phase of each mentoring path;
receiving data related to the defined metrics from a plurality of sources independent of a system which maintains the mentoring data, associating at least one of the programmatic triggers with values of the defined metrics, wherein the occurrence results from a receipt of the data from at least one of the sources.

7. The method of claim 1, wherein the mentoring relationships comprise a mentoring administrator relationship, wherein each mentoring relationship comprises at least one user defined within the mentoring data as having a mentor role, at least one user defined within the mentoring data as having the protégé role, and potentially at least one user defined within the mentoring data as having the mentoring administrator role, wherein each user involved in a mentoring relationship is presented with a user interface tailored according to their role in the mentoring relationship.

8. The method of claim 1, further comprising:
locating a plurality of managed electronic assets, useful towards progression along the mentoring path;
presenting a link to each of the located managed electronic assets within each of the interactive user interfaces alongside a portion of the mentoring path for which the managed electronic assets apply, wherein the links permit a user of the interactive user interface to access the located managed electronic assets.

9. The method of claim 8, permitting the sharing and collaboration upon the managed electronic assets by different users having different roles in the mentoring relationship using potentially different role tailored ones of the interactive user interfaces.

10. The method of claim 1, further comprising:
presenting the interactive user interfaces within a Web browser, wherein each of the interactive user interfaces represents a Web portal interface customized for mentoring purposes and tailored for a user based upon that user's mentoring role and the maintained mentoring data.

11. The method of claim 1, wherein each interactive user interface is an interface of a three-dimensional virtual world, wherein the mentoring relationship is a relationship established within the virtual world between at least two users one having a mentoring role and the other having a protégé role.

12. The method of claim 11, wherein real-world identities of the at least two users participating in the mentoring relationship are hidden from each other.

13. A system for providing an electronic professional mentoring environment comprising:
a mentorship path configured to define a series of interactions between at least one mentor and at least one protégé to achieve a predetermined end-goal for the protégé(s), wherein said mentorship path is supervised by potentially one or more mentorship administrators, and, wherein the series of interactions of the mentorship path comprises a plurality of phases, each having at least one activity to be performed; and
a mentorship framework configured to enable the at least one mentor, the at least one protégé, and the potentially at least one mentorship administrator to perform a plurality of operations within an electronic environment, wherein said plurality of operations signifies progression of the protégé along the mentorship path, and, wherein mentorship data generated by the plurality of operations is captured to create a knowledge base for use by the potentially at least one mentorship administrator to improve subsequent mentorship paths.

14. The system of claim 13, wherein the mentorship path is stored as an electronic document conforming to a standardized format, and, wherein a plurality of mentorship requirements are associated with at least one of a phase and an activity for the mentorship path.

15. The system of claim 13, wherein the mentorship framework further comprises:
a plurality of software tools configured to support execution of the plurality of operations within the electronic environment;
a plurality of content sources configured to provide the plurality of software tools with access to electronic data content; and
a repository configured to store the mentorship path and mentorship data.

16. The system of claim 15, wherein the plurality of software tools further comprises:
a mentorship server configured to perform a plurality of management functions for the mentorship path;
a communications server configured to support electronic communications for the plurality of software tools, wherein said electronic communications conform to standardized communication protocols;
a user experience server configured to control interface configuration for the at least one mentor, the at least one protégé, and the potentially at least one mentorship administrator with interfaces to the mentorship framework, wherein an interface configuration provides role-specific operations;
a collaboration server configured to support online collaboration functionality for electronic data content;
an asset management server configured to control versioning and access to the plurality of content sources;
an affiliation server configured to determine commonalities and relationships between the at least one mentor and the protégé, wherein said commonalities and relationships are utilized by the at least one mentorship administrator during creation of the mentorship path; and
a security server configured to restrict access to the mentorship framework to authorized mentors, protégés, and mentorship administrators.

17. The system of claim 15, wherein the mentorship server further comprises:
a mentorship path manager configured to handle creation and modification of the mentorship path; and
a federation engine configured to extract electronic data from the plurality of content sources for use with at least one of the mentorship toolset and the metrics tool.

18. A computer program product for implementing mentoring in conformance with a mentoring framework comprising a computer usable medium having computer usable program code embodied therewith, the computer program product comprising:
computer usable program code configured to establish a plurality of mentoring relationships between mentors and protégés within mentoring data maintained in a database structure that is digitally encoded in a storage medium, wherein the mentoring data conforms to standards of a mentoring framework;
computer usable program code configured to, for each mentoring relationship, establish a mentoring path, each mentoring path comprising a plurality of defined phases, each phase having a bounded beginning and ending, each phase further comprising at least one goal, at least one activity completion of which marks a progression towards achieving an associated goal, and timelines associated with at least one of the activities;
computer usable program code configured to present interactive user interfaces upon network attached client devices to users assigned a mentoring role who participate in at least one mentoring relationship for which the mentoring data is maintained in the storage medium, wherein each of the interactive user interfaces presents mentoring path information to a user in a manner customized for the mentoring role of that user, wherein said mentoring roles comprise at least a mentor role and a protégé role;
computer usable program code configured to receive performance input via the interactive user interfaces from a set of users, wherein the performance input is associated with a phase, goal, or activity of the mentoring path corresponding to the mentoring relationship of or being overseen by the user of the interactive user interface;
computer usable program code configured to update the mentoring data based upon performance input; and
computer usable program code configured to potentially change a progression along the mentoring path based upon the updated mentoring data.

19. The computer program product of claim 18, further comprising:
computer usable program code configured to federate data from a plurality of sources, wherein the federated data conforms to standards of the mentoring framework and is integrated within stages of the mentoring path; and
computer usable program code configured to update the mentoring data associated with a mentoring path based upon the federated data, wherein the plurality of sources comprise at least one social networking source, and at least one electronic communication source, each of which are implemented independent of the mentoring framework, wherein federating data from the plurality of sources involves transforming a format of semantic content extracted from each source from an original format to a format conforming to the mentoring framework, wherein semantic content extracted from each source is associated with programmatic triggers configured to selectively fire depending upon the semantic content, wherein firing results in an execution of a previously configured programmatic rule, which causes the mentoring data maintained in the storage medium to be automatically updated.

20. The computer program product of claim 18, wherein the mentoring relationships comprise a mentoring administrator relationship, wherein each mentoring relationship comprises at least one user defined within the mentoring data as having a mentor role, at least one user defined within the mentoring data as having the protégé role, and potentially at least one user defined within the mentoring data as having the mentoring administrator role, wherein each user involved in a mentoring relationship is presented within a user interface tailored according to their role in the mentoring relationship.
